(19) United States
(12) Patent Application Publication
(10) Pub. No.: US 2012/0200781 A1
(43) Pub. Date: Aug. 9, 2012

(54) DIGITAL BROADCAST RECEIVING APPARATUS

(75) Inventor: Kazuhisa TANAKA, Osaka (JP)

(73) Assignee: PANASONIC CORPORATION, Osaka (JP)

(21) Appl. No.: 13/446,641

(22) Filed: Apr. 13, 2012

Related U.S. Application Data
(63) Continuation of application No. PCT/JP2010/003279, filed on May 14, 2010.

(30) Foreign Application Priority Data
Oct. 15, 2009 (JP) 2009-238402

(51) Int. Cl. H04N 5/455

(52) U.S. Cl. 348/726; 348/E05.113

(57) ABSTRACT

In a digital broadcast receiving apparatus, a channel selection and demodulation section performs channel selection and demodulation processing for a broadcast wave of a digital broadcast received via an antenna. A microcomputer reads data stored in a nonvolatile memory via an access bus, stores a program included in the read data into a volatile memory, and executes the program. The digital broadcast receiving apparatus is configured to permit retrieval of transfer data on the access bus by the channel selection and demodulation section, and the channel selection and demodulation section recognizes a parameter used for the channel selection and demodulation processing and acquires the parameter, out of the transfer data on the access bus.

### CROSS-REFERENCE TO RELATED APPLICATION

This is a continuation of PCT International Application PCT/JP2010/003279 filed on May 14, 2010, which claims priority to Japanese Patent Application No. 2009-238402 filed on Oct. 15, 2009. The disclosures of these applications including the specifications, the drawings, and the claims are hereby incorporated by reference in their entirety.

### BACKGROUND

The present disclosure relates to a digital broadcast receiving apparatus that receives digital broadcasts and outputs images and sound.

In these days, digitalization of broadcasting, notably TV broadcasting, is in progress worldwide. The broadcast systems vary with countries and areas, but in most broadcast systems, video data, audio data, and other additional data (data for data broadcasts, program information, etc.) are subjected to multiplexing/compression/data redundancy before being broadcast on a carrier wave. This permits correct transmission/reception of a large amount of data with a reduced radio bandwidth, leading to achievement of multichannel broadcasts, high definition, enhanced sound quality, additional broadcasts, etc.

A digital broadcast receiving apparatus that receives digital broadcasts, such as a TV set, is configured to perform demultiplexing of multiplexed data, decompression of compressed data, detection/recovery of data dropouts/errors, etc. before outputting an image, sound, etc.

An example of such a digital broadcast receiving apparatus is disclosed in Japanese Patent Publication No. 2006-157595 (Patent Document 1), where, after a control/computation section sets parameters on broadcast stations for a demodulation section, the demodulation section starts demodulation operation, and an image and sound are output based on data demodulated by the demodulation section.

### SUMMARY

As described above, a general digital broadcast receiving apparatus performs high-volume information processing such as demultiplexing, decompression, detection and recovery of dropouts or errors of data, etc. Therefore, the time required from power-on until output of an image on a screen and sound from a speaker is long, compared with a general analog broadcast receiving apparatus. This becomes significant as the performance of the digital broadcast receiving apparatus improves by adoption of a broadcast system robust against data errors, etc. because the information processing amount increases.

Setting of parameters for the demodulation section by the control/computation section as in Patent Document 1 described above is generally performed by executing a program. In relation to this, before the parameter setting, the program is transferred in advance from a nonvolatile memory to a volatile memory to be stored in the volatile memory.

In the case of setting parameters as described above, however, the demodulation section is not allowed to start the demodulation operation until completion of the transfer of the program from the nonvolatile memory to the volatile memory and then the setting of parameters by executing the program. This increases the time required from power-on of the digital broadcast receiving apparatus until start of the demodulation operation, and as a result, increases the startup time from power-on until output of an image and sound.

In view of the above problem, it is an objective of the present disclosure to shorten the startup time from power-on of a digital broadcast receiving apparatus until output of an image or sound.

To attain the above objective, an embodiment of the present disclosure is a digital broadcast receiving apparatus configured to receive a digital broadcast and output an image and sound, including: a channel selection and demodulation section configured to perform channel selection and demodulation processing for a broadcast wave of the digital broadcast received via an antenna; an image and/or sound processing section configured to perform image processing and/or sound processing for data demodulated by the channel selection and demodulation section; and a processor configured to control a function of the digital broadcast receiving apparatus including the channel selection and demodulation section and the image and/or sound processing section, the processor reading data stored in a nonvolatile memory via an access bus, storing a program included in the read data into a volatile memory, and executing the program, wherein the digital broadcast receiving apparatus is configured to permit retrieval of transfer data on the access bus by the channel selection and demodulation section, and the channel selection and demodulation section has a function of recognizing a parameter used for the channel selection and demodulation processing and acquiring the parameter, out of the transfer data on the access bus.

According to the embodiment described above, the parameter used for the channel selection and demodulation processing can be acquired from the access bus and set in the middle of read of data stored in the nonvolatile memory. This permits the channel selection and demodulation section to start its channel selection and demodulation processing even when storing of a program into the volatile memory has not been completed. Thus, the startup time can be shortened compared with the conventional configuration where channel selection and demodulation processing is started after completion of storing of a program into a volatile memory.

According to the present disclosure, the channel selection and demodulation section can start its channel selection and demodulation processing even before completion of storing of a program into a volatile memory. Therefore, the startup time can be shortened compared with the conventional configuration where channel selection and demodulation processing is started after completion of storing of a program into a volatile memory.

### BRIEF DESCRIPTION OF THE DRAWINGS

FIG. 1 is a block diagram of a digital broadcast receiving apparatus of a first embodiment of the present disclosure.

FIG. 2 is a flowchart showing an operation of the digital broadcast receiving apparatus of the first embodiment.

FIG. 3 is a block diagram of a digital broadcast receiving apparatus of a variation of the first embodiment.

FIG. 4 is a block diagram of a digital broadcast receiving apparatus of a second embodiment of the present disclosure.

FIG. 5 is a flowchart showing an operation of a conventional digital broadcast receiving apparatus.

### DETAILED DESCRIPTION

Embodiments of the present disclosure will be described hereinafter with reference to the accompanying drawings.

### First Embodiment

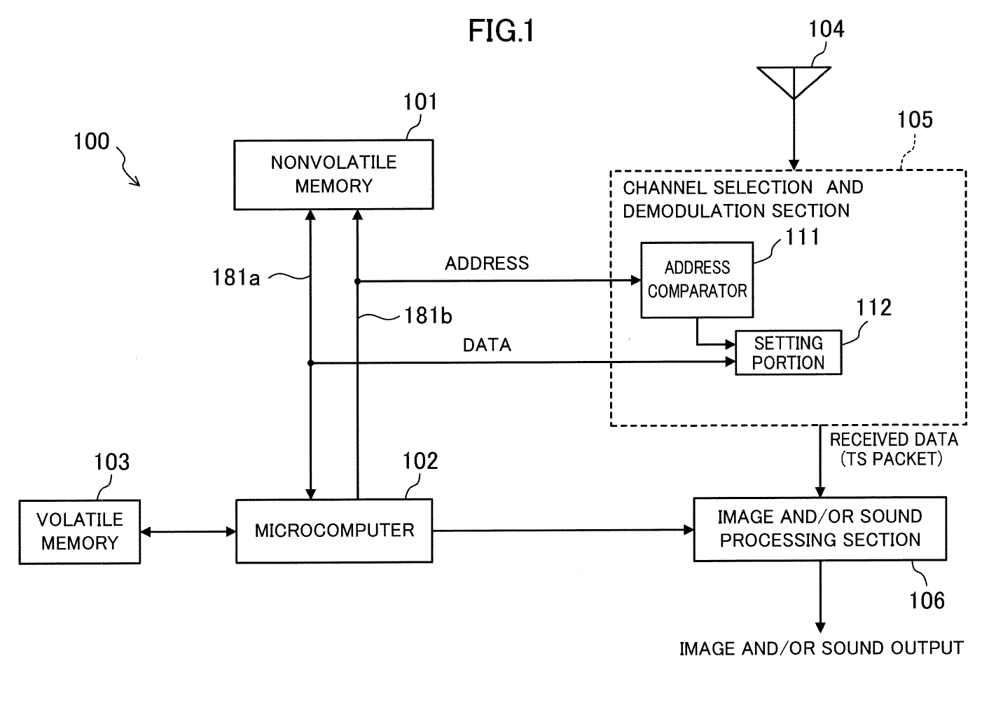

As shown in FIG. 1, a digital broadcast receiving apparatus 100 of the first embodiment of the present disclosure includes a nonvolatile memory 101, a microcomputer 102 as a processor, a volatile memory 103, an antenna 104, a channel selection and demodulation section 105, and an image and/or sound processing section 106. The nonvolatile memory 101, the microcomputer 102, and the channel selection and demodulation section 105 are connected to one another with an access bus 181a for data and an access bus 181b for addresses.

The nonvolatile memory 101, made of a flash memory, for example, stores data including a program executed by the microcomputer 102.

The volatile memory 103 is made of a synchronous dynamic random access memory (SDRAM), a double data rate SDRAM (DDR-SDRAM), etc.

The microcomputer 102 reads data stored in the nonvolatile memory 101 via the access bus 181a, and transfers a program included in the data read from the nonvolatile memory 101 to the volatile memory 103 to store the program therein. Thereafter, the microcomputer 102 executes the program stored in the volatile memory 103. In reading data stored in the nonvolatile memory 101 via the access bus 181a, the microcomputer 102 outputs an address of the read data to the access bus 181b.

The antenna 104 receives a broadcast wave of a digital broadcast.

The channel selection and demodulation section 105 performs channel selection and demodulation processing (retrieval of audio/video data and other digital data including auxiliary information from a carrier wave) for a broadcast wave of a digital broadcast received by the antenna 104. The channel selection and demodulation section 105 includes an address comparator 111 and a setting portion 112.

The address comparator 111 reads each address output by the microcomputer 102 from the access bus 181b and compares the read address with a predetermined value, to specify data corresponding to an address matching with the predetermined value, out of the data read from the nonvolatile memory 101 via the access bus 181a, to recognize the specified data as a setting parameter. The predetermined value may be changeable.

The setting portion 112 retrieves (acquires) the setting parameter recognized by the address comparator 111 from the access bus 181a, and sets the setting parameter as the parameter used for the channel selection and demodulation processing by the channel selection and demodulation section 105.

The image and/or sound processing section 106 performs image processing and/or sound processing for data (a transport stream (TS) packet) demodulated by the channel selection and demodulation section 105 and outputs the processed data. The image and/or sound processing performed by the image and/or sound processing section 106 includes descrambling, decompression of compressed video/audio data, correction of image quality, etc.

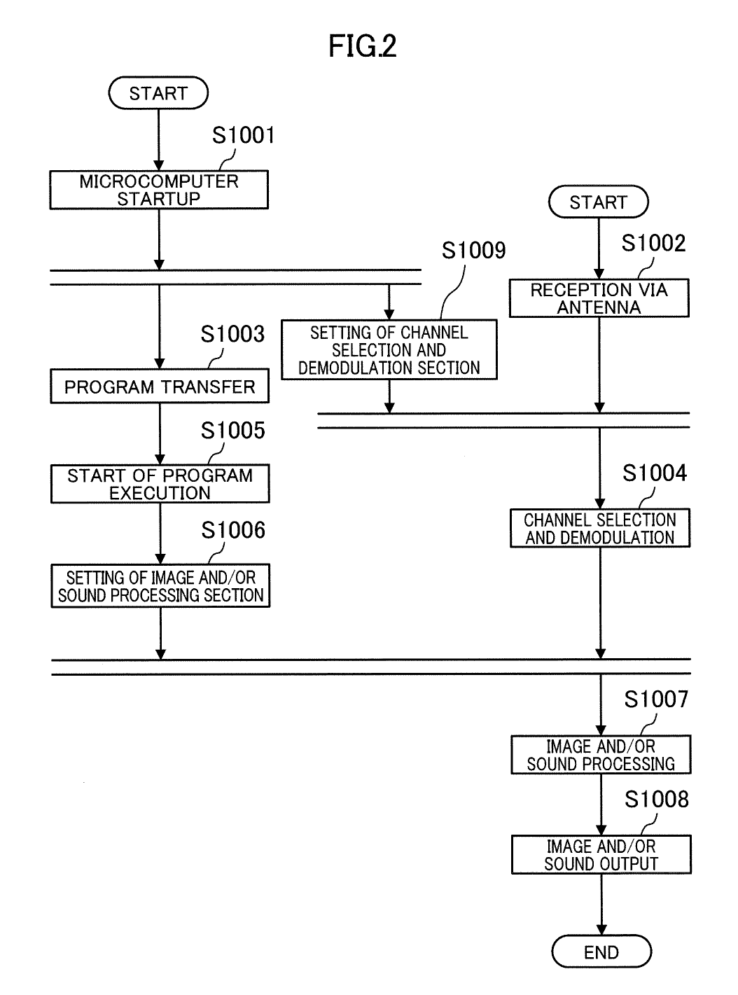

Next, an operation of the digital broadcast receiving apparatus 100 configured as described above will be described with reference to FIG. 2.

When the digital broadcast receiving apparatus 100 is powered on, first, the microcomputer 102 starts up in (S1001), reading a program from the nonvolatile memory 101 (accessing the nonvolatile memory 101) and starting execution of commands. At this time, the function blocks other than the microcomputer 102 do not start their operations because parameters required for the operations are not yet set.

In the meantime, in (S1002), the antenna 104 receives a digital broadcast wave.

When having completed initialization required for its operation in (S1001), the microcomputer 102 starts transfer operation of a program stored in the nonvolatile memory 101 to the volatile memory 103 in (S1003). This transfer operation includes reading data stored in the nonvolatile memory 101 via the access bus 181a and transferring a program included in the read data to the volatile memory 103 to store the program therein. During the transfer operation, in (S1009), the address comparator 111 of the channel selection and demodulation section 105 compares each address output from the nonvolatile memory 101 and passed to the access bus 181b with a predetermined value, to detect an address matching with the predetermined value. The address comparator 111 then recognizes data stored at the address matching with the predetermined value, out of groups of data output to the access bus 181a, as the setting parameter. Thereafter, the setting portion 112 retrieves the setting parameter recognized by the address comparator 111 from the access bus 181a, and sets the setting parameter as the parameter used for the channel selection and demodulation processing by the channel selection and demodulation section 105.

When setting of the parameter in (S1009) is completed, in (S1004), the channel selection and demodulation section 105 performs the channel selection and demodulation processing for the broadcast wave received by the antenna 104 using the parameter set by the setting portion 112 in (S1009).

In the meantime, when having completed the transfer operation of the program to the volatile memory 103, the microcomputer 102 starts execution of the program stored in the volatile memory 103 in (S1005). After the sections of the digital broadcast receiving apparatus 100 have been initialized by the execution of the program, the sections start their operations. Note that the transfer operation of the program to be completed at this stage may be transfer operation of all programs, or may be transfer operation of a program required for an immediate operation of the digital broadcast receiving apparatus 100 (system). In (S1006), the microcomputer 102 sets the parameter used for the image and/or sound processing by the image and/or sound processing section 106 by executing the program.

When the channel selection and demodulation processing in (S1004) and the setting of the parameter for the image and/or sound processing section 106 in (S1006) are completed, the image and/or sound processing section 106 performs the image processing and/or the sound processing for data demodulated by the channel selection and demodulation section 105 in (S1007), and outputs processed video data and/or audio data in (S1008).

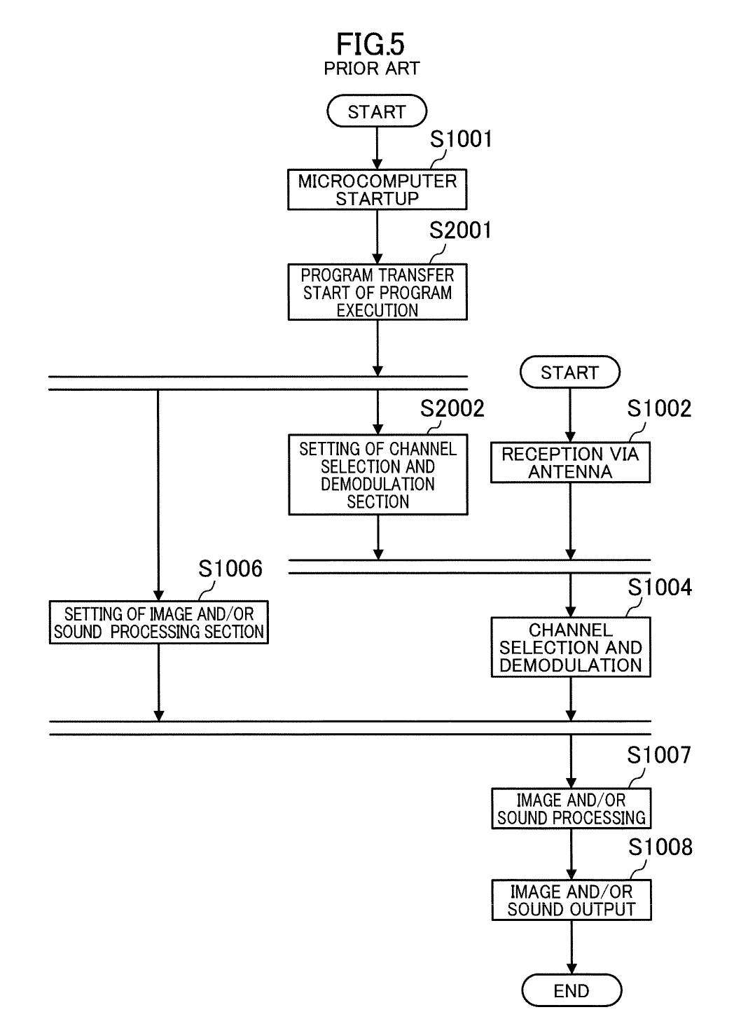

In the conventional digital broadcast receiving apparatus, as shown in FIG. 5, the channel selection and demodulation processing in (S1004) can be started only after transfer of a program is completed to start execution of the program in (S2001) and a parameter is set for the channel selection and demodulation section 105 by execution of the program in (S2002). Note that, in the procedure of FIG. 5, the same steps as those in FIG. 2 are denoted by the same reference characters and description of such steps is omitted here.

Contrarily, in this embodiment, in the middle of read of data stored in the nonvolatile memory 101 by the microcomputer 102, the setting portion 112 retrieves a parameter for the channel selection and demodulation section 105 from the access bus 181a and sets the parameter. Also, before completion of storing of the program into the volatile memory 103, the channel selection and demodulation section 105 starts the channel selection and demodulation processing, to permit execution of the channel selection and demodulation processing in parallel with the transfer operation of the program in (S1003). Therefore, compared with the flow in FIG. 5 where the channel selection and demodulation processing is started after completion of storing of the program into the volatile memory 103, the startup time can be shortened.

### First Variation of First Embodiment

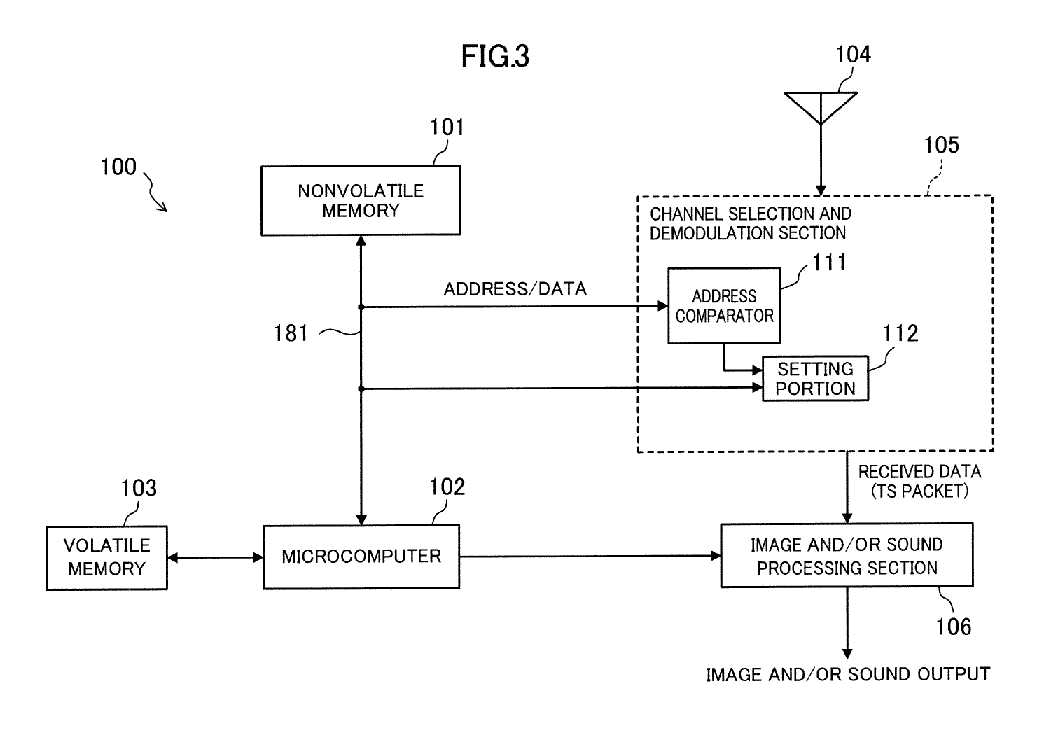

FIG. 3 shows a digital broadcast receiving apparatus 100 of a first variation of the first embodiment of the present disclosure. In this variation, as shown in FIG. 3, a common access bus 181 is used for transfer of addresses, write data, and read data. In other words, in writing write data into the nonvolatile memory 101, addresses and write data are transferred serially via the common access bus 181. In reading read data from the nonvolatile memory 101, addresses and read data are transferred serially via the common access bus 181.

The other configuration and operation are the same as those in the first embodiment, and thus detailed description thereof is omitted here.

### Second Variation of First Embodiment

In a second variation of the first embodiment, a plurality of groups of data usable as the parameter for the channel selection and demodulation processing are stored in the nonvolatile memory 101, and also an error flag (error information) indicating presence/absence of an error is stored for each group of data. The address comparator 111 determines presence/absence of an error for data corresponding to an address matching with a predetermined value based on the error flag, and if determining that an error is present, changes the predetermined value and performs re-specifying processing of specifying data at an address matching with the changed predetermined value. The address comparator 111 repeats this re-specifying processing until determining that no error is present for data corresponding to an address matching with the predetermined value, and recognizes the data indicated as being error-free by the error flag as the setting parameter.

The other configuration and operation are the same as those in the first embodiment, and thus detailed description thereof is omitted here.

Note that, although presence/absence of an error is determined based on the error flag in this variation, it may be determined based on the entire data (error information) including a redundancy bit for error detection if such a redundancy bit is included in each unit of data.

### Second Embodiment

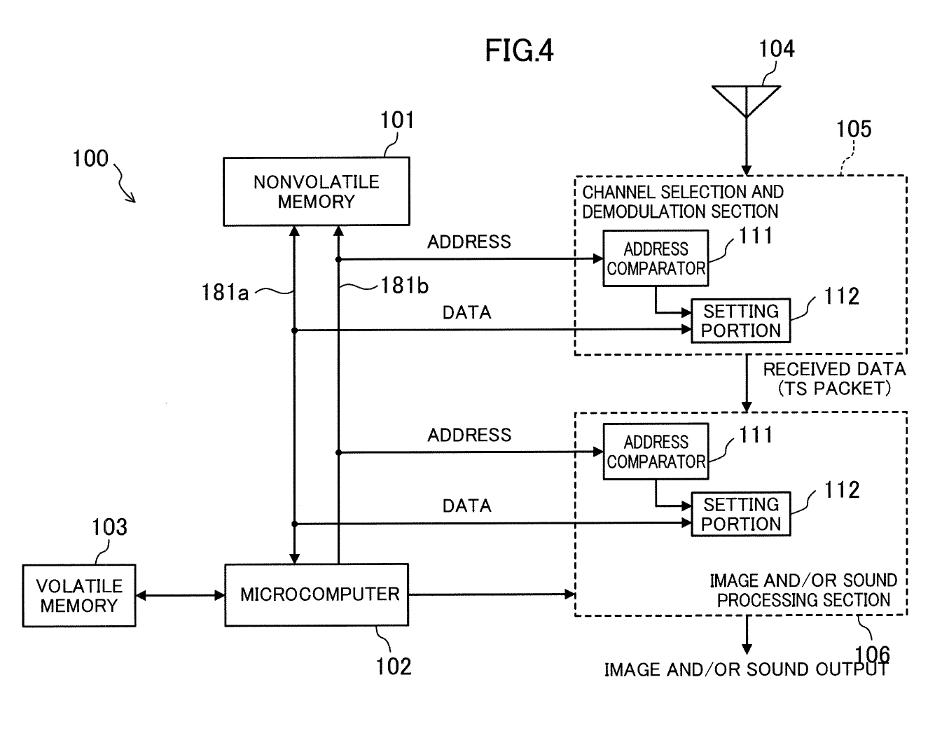

FIG. 4 shows a digital broadcast receiving apparatus 100 of the second embodiment of the present disclosure. In the digital broadcast receiving apparatus 100 of this embodiment, the image and/or sound processing section 106 also includes an address comparator 111 and a setting portion 112.

The address comparator 111 in the image and/or sound processing section 106 compares each address output from the nonvolatile memory 101 and passed to the access bus 181b with a predetermined value, and specifies data corresponding to an address matching with the predetermined value, out of the data read from the nonvolatile memory 101 via the access bus 181a, to recognize the specified data as the setting parameter.

The setting portion 112 in the image and/or sound processing section 106 retrieves (acquires) the setting parameter recognized by the address comparator 111 from the access bus 181a, and sets the setting parameter as the parameter used for the image processing or the sound processing by the image and/or sound processing section 106. The setting parameter recognized by the address comparator 111 in the image and/or sound processing section 106 is different from the setting parameter recognized by the address comparator 111 in the channel selection and demodulation section 105.

The image and/or sound processing section 106 then performs the image processing and/or the sound processing for data demodulated by the channel selection and demodulation section 105 using the setting parameter recognized by its address comparator 111, and outputs the resultant data.

The other configuration and operation are the same as those in the first embodiment, and thus detailed description thereof is omitted here.

In the first embodiment, even when the channel selection and demodulation processing in (S1009) is completed, the image and/or sound processing in (S1007) cannot be started unless setting of the parameter used for the image and/or sound processing in (S1006) is completed. This causes the possibility that a latency may occur from completion of the channel selection and demodulation processing until start of the image and/or sound processing. In the second embodiment, however, the setting portion 112 of the image and/or sound processing section 106 sets a parameter in the middle of read of data stored in the nonvolatile memory 101, permitting the image and/or sound processing section 106 to start the image processing and/or the sound processing even before completion of storing of the program into the volatile memory 103. Thus, without occurrence of a latency as described above, increase in startup time can be prevented more reliably.

In the first and second embodiments and the first and second variations of the first embodiment, the address comparator 111 specifies a parameter used for channel selection, demodulation, image processing, or sound processing based on an address output to the access bus 181b or 181. However, the method of specifying a parameter is not limited to this. For example, data passing through the access bus 181a or 181 at the time when a control signal passing through a signal path other than the access bus 181a, 181b, or 181 satisfies a predetermined condition may be specified as the parameter used for channel selection, demodulation, image processing, or sound processing. The predetermined condition may be changeable.

In the first and second embodiments and the first and second variations of the first embodiment, the common access bus 181a or 181 is used for writing write data into the nonvolatile memory 101 and reading read data from the nonvolatile memory 101. Alternatively, individual access buses may be used.

As described above, the digital broadcast receiving apparatus of the present disclosure has an advantage that the startup time can be shortened, and thus is useful as a digital broadcast receiving apparatus that receives digital broadcasts and outputs images and sound.

What is claimed is:

1. A digital broadcast receiving apparatus configured to receive a digital broadcast and output an image and sound, comprising:
a channel selection and demodulation section configured to perform channel selection and demodulation processing for a broadcast wave of the digital broadcast received via an antenna;
an image and/or sound processing section configured to perform image processing and/or sound processing for data demodulated by the channel selection and demodulation section; and
a processor configured to control a function of the digital broadcast receiving apparatus including the channel selection and demodulation section and the image and/or sound processing section, the processor reading data stored in a nonvolatile memory via an access bus, storing a program included in the read data into a volatile memory, and executing the program,
wherein
the digital broadcast receiving apparatus is configured to permit retrieval of transfer data on the access bus by the channel selection and demodulation section, and
the channel selection and demodulation section has a function of recognizing a parameter used for the channel selection and demodulation processing and acquiring the parameter, out of the transfer data on the access bus.

2. The digital broadcast receiving apparatus of claim 1, wherein
the processor outputs an address of data read from the nonvolatile memory to the access bus, and
the channel selection and demodulation section acquires, as the parameter, data of which the address output by the processor is a predetermined value.

3. The digital broadcast receiving apparatus of claim 2, wherein
the predetermined value is changeable.

4. The digital broadcast receiving apparatus of claim 1, wherein
the processor outputs an address of data read from the nonvolatile memory,
the access bus is commonly used for the address and at least either write data or read data, and
the channel selection and demodulation section acquires, as the parameter, data passing through the access bus at the time when the data itself is a predetermined value or when a control signal passing through a signal path other than the access bus satisfies a predetermined condition.

5. The digital broadcast receiving apparatus of claim 4, wherein
the predetermined value or the predetermined condition is changeable.

6. The digital broadcast receiving apparatus of claim 1, wherein
a plurality of groups of data usable as the parameter for the channel selection and demodulation processing are stored in the nonvolatile memory, and error information indicating presence/absence of an error is stored for each group of data, and
the channel selection and demodulation section has a function of recognizing data indicated as being error-free by the error information stored in the nonvolatile memory as the parameter used for the channel selection and demodulation processing and acquiring the data, out of the transfer data on the access bus.

7. The digital broadcast receiving apparatus of claim 1, wherein
the digital broadcast receiving apparatus is configured to permit retrieval of the transfer data on the access bus by the image and/or sound processing section, and
the image and/or sound processing section has a function of recognizing a parameter used for the image processing or the sound processing and acquiring the parameter, out of the transfer data on the access bus.
